(19) United States
(12) Patent Application Publication
(10) Pub. No.: US 2021/0067945 A1
(43) Pub. Date: Mar. 4, 2021

(54) AUTONOMOUS RADIO ACCESS NETWORK NOTIFICATION AREA CONFIGURATION

(71) Applicant: Qualcomm Incorporated, San Diego, CA (US)

(72) Inventors: Huichun Liu, Beijing (CN); Gavin Bernard Horn, La Jolla, CA (US); Luis Femando Brisson Lopes, Swindon (GB)

(21) Appl. No.: 16/958,149

(22) PCT Filed: Dec. 25, 2017
(86) PCT No.: PCT/CN2017/118206

§ 371 Date: Jun. 25, 2020

(51) Int. Cl. H04W 8/08; H04W 76/10; H04W 36/00

(52) U.S. Cl. CPC H04W 8/08; H04W 36/0083; H04W 76/10

(57) ABSTRACT

Methods, systems, and devices for wireless communications are described. A user equipment (UE) may transition from a connected state with a first cell to an inactive state and identify a notification area configured for the inactive state including the first cell. The UE may reselect, while in the inactive state and independently of the first cell, to a second cell and identify a trigger for reporting mobility history information. The mobility history information may include a set of previously cells to which the UE has previously attached and corresponding notification areas for each of the set of cells. The UE may report the mobility history information based on the trigger.

### CROSS REFERENCE

The present Application is a 371 national phase filing of International Patent Application No. PCT/CN2017/118206 by Liu et al., entitled “AUTONOMOUS RADIO ACCESS NETWORK NOTIFICATION AREA CONFIGURATION,” filed Dec. 25, 2017, assigned to the assignee hereof.

### BACKGROUND

The following relates generally to wireless communication, and more specifically to autonomous radio access network (RAN) notification area configuration.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

In some wireless communications systems, a UE may be highly mobile within a tracking area. In some cases, a core network may be notified by a radio access network (RAN) each time that the UE reselects to a different cell in the tracking area for the core network to page the UE. If the UE reselects cells often, the many notifications to the core network may adversely affect throughput in the RAN.

### SUMMARY

A base station may configure a radio access network (RAN) notification area (RNA) for a user equipment (UE) upon the UE entering an inactive state for radio resource control (RRC) signaling. The RNA may be specific to the UE and include a list of cells associated with the RNA. In some cases, the cells in the RNA may be connected by logical connections, which the cells may use to communicate access stratum or non-access stratum signaling for the UE. In the inactive state, the UE may move within the RNA and attach to cells in the RNA without notifying the RAN. The UE may keep a connection history of cells to which it has previously attached and RNAs associated with the cells. In some cases, the RAN may manage an RNA configuration for a UE based on a connection history and mobility of the UE. For example, if the UE attaches to a cell not in the RNA, the UE may transmit its mobility information and connection history in an autonomous RNA configuration (auto-RAC) report during RRC connection setup. The RAN may determine whether the cell should join the RNA of the UE based on the mobility information and connection history of the UE. In some other examples, the auto-RAC report may transmitted by the UE to a cell already in the UE-specific RNA, and the base station associated with the cell may determine whether the cell should remain in the RNA. Thus, a larger RNA may be divided if the auto-RAC report indicates that the UE may not frequently attach to a cell of the larger RNA. In some cases, the RAN may connect or disconnect logical connections between cells in the RNA based on cells joining or leaving the RNA. Based on the auto-RAC report, the RAN may determine that the UE often selects a cell of a neighboring RNA and change the UE RNA list to include the cell of the neighboring RNA, reducing the number of RRC connection registrations for RAN-based notification area updates (RNAUs)

A method of wireless communication is described. The method may include transitioning, at a UE, from a connected state with a first cell to an inactive state, identifying a notification area configured for the inactive state comprising at least the first cell, reselecting, while in the inactive state and independently of the first cell, to a second cell, identifying, while in the inactive state, a trigger for reporting mobility history information, and reporting the mobility history information based at least in part on the trigger, the mobility history information comprising a plurality of cells to which the UE has previously attached and corresponding notification areas for each of the plurality of cells.

An apparatus for wireless communication is described. The apparatus may include means for transitioning, at a UE, from a connected state with a first cell to an inactive state, means for identifying a notification area configured for the inactive state comprising at least the first cell, means for reselecting, while in the inactive state and independently of the first cell, to a second cell, means for identifying, while in the inactive state, a trigger for reporting mobility history information, and means for reporting the mobility history information based at least in part on the trigger, the mobility history information comprising a plurality of cells to which the UE has previously attached and corresponding notification areas for each of the plurality of cells.

Another apparatus for wireless communication is described. The apparatus may include a processor, memory in electronic communication with the processor, and instructions stored in the memory. The instructions may be operable to cause the processor to transition, at a UE, from a connected state with a first cell to an inactive state, identify a notification area configured for the inactive state comprising at least the first cell, reselect, while in the inactive state and independently of the first cell, to a second cell, identify, while in the inactive state, a trigger for reporting mobility history information, and report the mobility history information based at least in part on the trigger, the mobility history information comprising a plurality of cells to which the UE has previously attached and corresponding notification areas for each of the plurality of cells.

A non-transitory computer-readable medium for wireless communication is described. The non-transitory computer-readable medium may include instructions operable to cause a processor to transition, at a UE, from a connected state with a first cell to an inactive state, identify a notification area configured for the inactive state comprising at least the first cell, reselect, while in the inactive state and independently of the first cell, to a second cell, identify, while in the inactive state, a trigger for reporting mobility history information, and report the mobility history information based at least in part on the trigger, the mobility history information comprising a plurality of cells to which the UE has previously attached and corresponding notification areas for each of the plurality of cells.

In some examples of the method, apparatus, and non-transitory computer-readable medium described above, identifying the trigger for reporting mobility history information comprises identifying that the second cell may be not within the notification area.

In some examples of the method, apparatus, and non-transitory computer-readable medium described above, identifying the trigger for reporting mobility history information comprises: identifying, upon the reselecting to the second cell, that a neighbor list for the second cell excludes the first cell.

In some examples of the method, apparatus, and non-transitory computer-readable medium described above, identifying the trigger for reporting mobility history information comprises: performing a connection setup procedure or a connection resume procedure.

In some examples of the method, apparatus, and non-transitory computer-readable medium described above, identifying the trigger for reporting mobility history information comprises: receiving a request for the mobility history information.

In some examples of the method, apparatus, and non-transitory computer-readable medium described above, identifying the trigger for reporting mobility history information is based at least in part on expiration of a timer associated with periodic reporting of the mobility history information.

Some examples of the method, apparatus, and non-transitory computer-readable medium described above may further include processes, features, means, or instructions for reporting the mobility history information comprises reporting the mobility history information to the second cell as part of a connection setup procedure, a connection resume procedure, or a notification area update procedure.

In some examples of the method, apparatus, and non-transitory computer-readable medium described above, the plurality of cells comprises a predetermined number of cells.

In some examples of the method, apparatus, and non-transitory computer-readable medium described above, while in the inactive state, the UE maintains an access stratum context associated with a session connection and may be configured for autonomous cell reselection.

A method of wireless communication is described. The method may include receiving, by a base station associated with the second cell, mobility history information from a UE via the second cell, the mobility history information comprising a plurality of cells to which the UE has previously attached and corresponding notification areas for each of the plurality of cells, the UE having reselected to the second cell in an inactive state, identifying, based at least in part on the mobility history information, that the first cell is an anchor cell for the UE and a notification area corresponding to the first cell for the UE, and determining, based at least in part on the mobility history information, whether to associate or disassociate the second cell with the notification area.

An apparatus for wireless communication is described. The apparatus may include means for receiving, by a base station associated with the second cell, mobility history information from a UE via the second cell, the mobility history information comprising a plurality of cells to which the UE has previously attached and corresponding notification areas for each of the plurality of cells, the UE having reselected to the second cell in an inactive state, means for identifying, based at least in part on the mobility history information, that the first cell is an anchor cell for the UE and a notification area corresponding to the first cell for the UE, and means for determining, based at least in part on the mobility history information, whether to associate or disassociate the second cell with the notification area.

Another apparatus for wireless communication is described. The apparatus may include a processor, memory in electronic communication with the processor, and instructions stored in the memory. The instructions may be operable to cause the processor to receive, by a base station associated with the second cell, mobility history information from a UE via the second cell, the mobility history information comprising a plurality of cells to which the UE has previously attached and corresponding notification areas for each of the plurality of cells, the UE having reselected to the second cell in an inactive state, identify, based at least in part on the mobility history information, that the first cell is an anchor cell for the UE and a notification area corresponding to the first cell for the UE, and determine, based at least in part on the mobility history information, whether to associate or disassociate the second cell with the notification area.

A non-transitory computer-readable medium for wireless communication is described. The non-transitory computer-readable medium may include instructions operable to cause a processor to receive, by a base station associated with the second cell, mobility history information from a UE via the second cell, the mobility history information comprising a plurality of cells to which the UE has previously attached and corresponding notification areas for each of the plurality of cells, the UE having reselected to the second cell in an inactive state, identify, based at least in part on the mobility history information, that the first cell is an anchor cell for the UE and a notification area corresponding to the first cell for the UE, and determine, based at least in part on the mobility history information, whether to associate or disassociate the second cell with the notification area.

In some examples of the method, apparatus, and non-transitory computer-readable medium described above, the second cell may be not associated with the notification area upon receiving the mobility history information for the UE, and the method, apparatus, and non-transitory computer-readable medium described above may further include processes, features, means, or instructions for determining to associate the second cell with the notification area for the UE, the method further comprising sending a setup request for a logical connection between the first cell and the second cell.

Some examples of the method, apparatus, and non-transitory computer-readable medium described above may further include processes, features, means, or instructions for retrieving a context for the UE from the first cell. Some examples of the method, apparatus, and non-transitory computer-readable medium described above may further include processes, features, means, or instructions for performing a connection switch procedure to switch a session connection for the UE from the first cell to the second cell. Some examples of the method, apparatus, and non-transitory computer-readable medium described above may further include processes, features, means, or instructions for performing a notification area registration to associate the second cell with the notification area for the UE.

Some examples of the method, apparatus, and non-transitory computer-readable medium described above may further include processes, features, means, or instructions for receiving, from a core network, downlink data traffic for the UE. Some examples of the method, apparatus, and non-transitory computer-readable medium described above may further include processes, features, means, or instructions for sending, via the logical connection, a paging request to the first cell to page the UE via the first cell.

Some examples of the method, apparatus, and non-transitory computer-readable medium described above may further include processes, features, means, or instructions for receiving a setup response indicating a failure to setup the logical connection between the first cell and the second cell. Some examples of the method, apparatus, and non-transitory computer-readable medium described above may further include processes, features, means, or instructions for determining to refrain from associating the second cell with the notification area for the UE.

In some examples of the method, apparatus, and non-transitory computer-readable medium described above, the second cell may be associated with the notification area upon receiving the mobility history information for the UE, and wherein the determining comprises determining to disassociate the second cell with the notification area for the UE based at least in part on the mobility history information.

Some examples of the method, apparatus, and non-transitory computer-readable medium described above may further include processes, features, means, or instructions for performing a notification area registration to disassociate the second cell from the notification area for the UE.

In some examples of the method, apparatus, and non-transitory computer-readable medium described above, the second cell may be associated with a second, different notification area upon receiving the mobility history information for the UE, and the method, apparatus, and non-transitory computer-readable medium described above may further include processes, features, means, or instructions for determining to merge the second notification area with the notification area.

### BRIEF DESCRIPTION OF THE DRAWINGS

FIG. 1 illustrates an example of a system for wireless communication that supports autonomous radio access network (RAN) notification area configuration in accordance with aspects of the present disclosure.

FIG. 2 illustrates an example of a wireless communications system that supports autonomous RAN notification area configuration in accordance with aspects of the present disclosure.

FIG. 3 illustrates an example of a process flow that supports autonomous RAN notification area configuration in accordance with aspects of the present disclosure.

FIG. 4 illustrates an example of a process flow that supports autonomous RAN notification area configuration in accordance with aspects of the present disclosure.

FIGS. 5 through 7 show block diagrams of a device that supports autonomous RAN notification area configuration in accordance with aspects of the present disclosure.

FIG. 8 illustrates a block diagram of a system including a UE that supports autonomous RAN notification area configuration in accordance with aspects of the present disclosure.

FIGS. 9 through 11 show block diagrams of a device that supports autonomous RAN notification area configuration in accordance with aspects of the present disclosure.

FIG. 12 illustrates a block diagram of a system including a base station that supports autonomous RAN notification area configuration in accordance with aspects of the present disclosure.

FIGS. 13 through 14 illustrate methods for autonomous RAN notification area configuration in accordance with aspects of the present disclosure.

### DETAILED DESCRIPTION

A base station may configure a radio access network (RAN) notification area (RNA) for a user equipment (UE) prior to or upon the UE entering an inactive state for radio resource control (RRC) signaling. The RNA may be specific to the UE and include a list of cells associated with the RNA. In some cases, the cells in the RNA may be connected by logical connections (e.g., Xn or X2 connections), which the cells may use to communicate access stratum or non-access stratum signaling for the UE. In the inactive state, the UE may move within the RNA and attach to cells in the RNA without notifying the RAN. The UE may keep a connection history of cells to which it has previously attached and RNAs associated with the cells. A core network may consider the UE to be in a connected state while the UE is in inactive state, and the UE may switch between the RRC inactive and RRC connected states without the core network being notified. In some cases, the terms “cell” and “base station” may be used interchangeably, where a cell corresponds to a cell of a base station, and transmitting to or receiving from a base station implies transmission or reception on a cell of the base station. The RAN may provide mobile connectivity for UEs over a radio access technology (RAT) via multiple access points, such as base stations, and interfaces with the core network for connectivity to IP-based or circuit-switched networks.

In some cases, the RAN may manage an RNA configuration for a UE based on a connection history and mobility of the UE. In a first example, if the UE attaches to a cell not in the RNA (e.g., associated with another RNA), the UE may transmit its mobility information and connection history in an autonomous RNA configuration (auto-RAC) report during RRC connection setup. The RAN may determine whether the cell should join the RNA of the UE based on the mobility information and connection history of the UE. For example, if the auto-RAC report indicates that the UE frequently attaches to the cell from other cells of the RNA, the RAN may determine for the cell to join the RNA. The cell may then establish logical connections (e.g., Xn or X2 connections) with the other cells in the RNA. In some cases, the RNA of the cell and the RNA of the UE may merge or combine. In some other examples, the auto-RAC report may transmitted by the UE to a cell in the UE-specific RNA, and the base station associated with the cell may determine whether the cell should remain in the RNA. Thus, a larger RNA may be divided if the auto-RAC report indicates that the UE may not frequently attach to a cell of the larger RNA. In some cases, cells in the RNA may connect or disconnect the logical connections based on cells joining or leaving the RNA. Based on the auto-RAC report, the RAN may determine that the UE often selects a cell of a neighboring RNA and change the UE RNA list to include the cell of the neighboring RNA, reducing the number of RRC connection registrations for RAN-based notification area updates (RNAUs).

Aspects of the disclosure are initially described in the context of a wireless communications system. Aspects of the disclosure are further illustrated by and described with reference to apparatus diagrams, system diagrams, and flowcharts that relate to autonomous RAN notification area configuration.

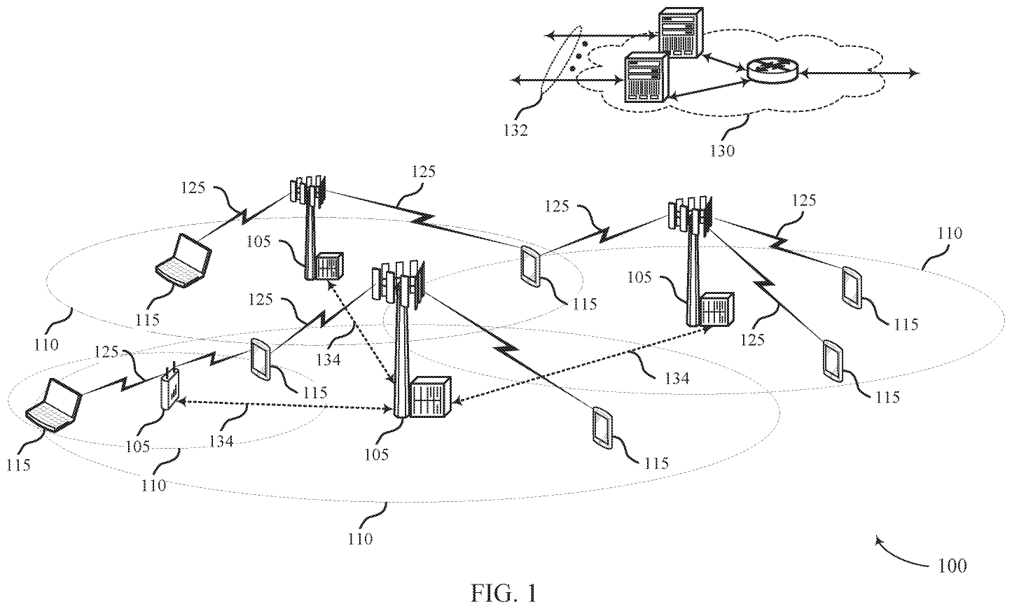

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or packet data convergence protocol (PDCP) layer may be IP-based. A radio link control (RLC) layer may in some cases perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the RRC protocol layer may provide establishment, configuration, and maintenance of an RRC connection between a UE 115 and a base station 105 or core network 130 supporting radio bearers for user plane data. At the physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as Tf=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

Wireless communications system 100 may support techniques for autonomous RNA configuration and updating as described herein. A base station 100 may configure an RNA for a UE 115 entering an inactive state for RRC signaling. The RNA may be specific to the UE 115 and include a list of cells associated with the RNA. The cells in the RNA may be connected by logical connections, which the cells may use to communicate access stratum or non-access stratum signaling for the UE. In the inactive state, the UE 115 may move within the RNA and attach to cells in the RNA without notifying the RAN. The UE 115 may keep a connection history of cells to which it has previously attached and RNAs associated with the cells.

The RAN may manage an RNA configuration for the UE 115 based on the connection history and mobility of the UE 115. In a first example, if the UE 115 attaches to a cell not in the RNA, the UE 115 may transmit its mobility information and connection history in an auto-RAC report during RRC connection setup. The RAN may determine whether the cell should join the RNA based on the mobility information and connection history of the UE 115. For example, if the auto-RAC report indicates that the UE 115 frequently attaches to the cell from other cells in the RNA, the RAN may determine for the cell to join the RNA. The cell may then establish logical connections with the other cells in the RNA. In some other examples, the auto-RAC report may be transmitted by the UE 115 to a cell already in the RNA, and the RAN may determine whether the cell should remain in the RNA. Thus, an RNA may be reduced if the auto-RAC report indicates that the UE 115 may not frequently attach to a cell of the RNA. Cells in the RNA may establish or disconnect logical connections based on cells joining or leaving the RNA.

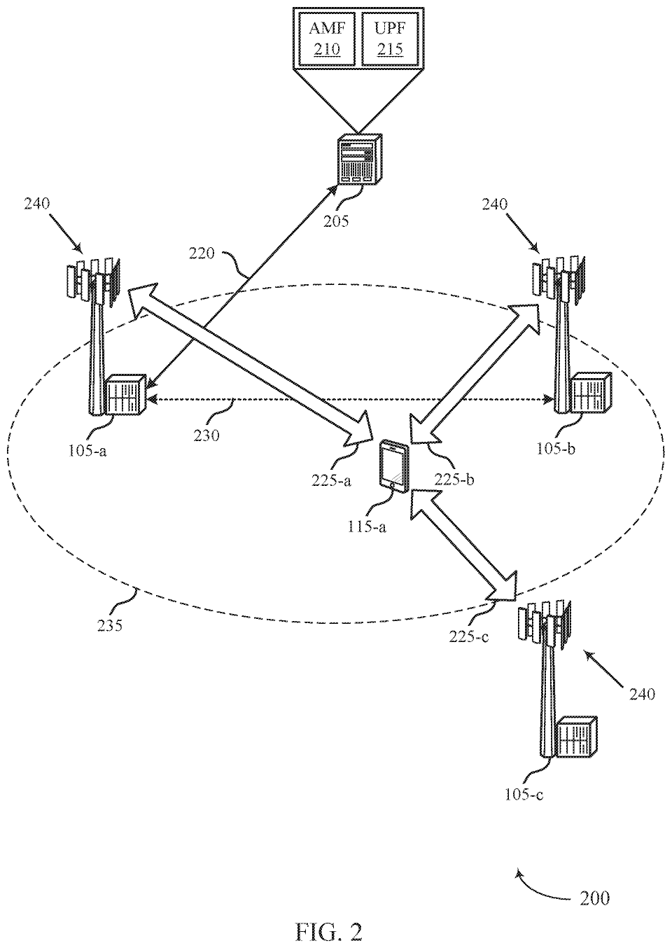

FIG. 2 illustrates an example of a wireless communications system 200 that supports autonomous RAN notification area configuration in accordance with various aspects of the present disclosure. In some examples, wireless communications system 200 may implement aspects of wireless communication system 100. Wireless communications system 200 may include base station 105-a and base station 105-b, which may be examples of a base station 105 described herein, as well as UE 115-a, which may be an example of a UE 115 described herein.

Base station 105-a may connect to a core network 205 via a backhaul link 220. The core network 205 may include an access and mobility management function (AMF) 210 and a user plane function (UPF) 215. UE 115-a may communicate with core network 205 via cells 225 of a RAN 240 including one or more base stations 105.

In a first instance, UE 115-a may attach to base station 105-a and enter a connected state. For example, UE 115-a may perform a random access procedure and establish a RRC connection to base station 105-a. With UE 115-a in the connected state, base station 105-a may establish a context for UE 115-a and establish an access stratum (AS) session with the core network 205 (e.g., via UPF 215) associated with UE 115-a. The UE context may include a first signaling radio bearer for RRC signaling, such as radio resource management, mobility etc., and a second signaling radio bearer for NAS messages which may be forwarded to the AMF 210. The UE context may further include one or more data radio bearers for user data of UE 115-a. That is, base station 105-a may be an anchor base station 105 for UE 115-a within RAN 240. UE 115-a may also establish an AS context associated with the AS session, which may include a radio bearer for communications between the RAN 240 and UE 115-a.

From the connected state with base station 105-a, UE 115-a may enter an inactive state. The RAN 240 may configure the RNA 235 for UE 115-a prior to or while releasing UE 115-a to the inactive state. The RNA 235 may be configured based on a number of factors, such as mobility information or a mobility rating of UE 115-a, system information, whether UE 115-a is in a new or old RAN area, or any combination thereof. In a first example, the RAN 240 may configure RNA 235 for UE 115-a including cell 225-a of base station 105-a and cell 225-b of base station 105-b. Cell 225-c of base station 105-c, while included in the RAN 240, may not be included in the RNA 235. UE 115-a and base station 105-a may each maintain the active state UE context while UE 115-a is in the inactive state. Thus, in the inactive state, the core network 205 may consider UE 115-a to remain in a connected state. For example, the core network 205 may maintain the session connection for UE 115-a with base station 105-a. However, the RRC connection between UE 115-a and base station 105-a may be released.

In the inactive state, the RAN 240 may manage paging for UE 115-a via intra-RAN communication. If RAN-based paging fails, base station 105-a may release the context and session connection and return paging to the core network 205, which may initiate paging based on a last-known tracking or registration area for UE 115-a. The inactive state may reduce signaling between base stations 105 and the core network 205 as the core network 205 may not be notified each time the UE 115 changes states between the inactive state and the connected state. In some cases, a UE 115 in the inactive state may follow idle state cell reselection behavior within the RNA 235 while appearing to the core network 205 as still being connected to the anchor base station 105 of RAN 240.

The RAN 240 may configure the RNA 235 for UE 115-a. For example, the RNA 235 of UE 115-a may be a list of cells. Additionally or alternatively, the RNAs 235 may be cell-specific. For example, each cell 225 may have an attribute which indirectly identifies whether the cell 225 belongs to the RNA 235. Each cell may broadcast its associated RNA in system information. In some cases, a UE-specific RNA may be a list of cell-specific RNAs.

UE 115-a may move within the RNA 235 without notifying the RAN 240 of changes in location. UE 115-a may camp on different cells 225 (e.g., via cell reselection) of the RNA 235 while moving and without notifying the RAN 240. For example, UE 115-a may camp on base station 105-b and read system information transmitted by base station 105-b. UE 115-a may record the cell ID and corresponding RNA of base station 105-b.

An RNA 235 for a UE 115 may be defined by a list of cells 225, a list of registration areas or tracking areas, or a list of RNAs where each RNA includes one or more cells. The RNA 235 may include cells 225 to which UE 115-a frequently connects, cells 225 to which UE 115-a may be predicted to connect, or cells to which UE 115-a has previously connected. The RNA 235 may be specific to UE 115-a. Cells 225 may be associated with RNAs, even when not included in the UE-specific RNA 235. For example, cell 225-c may be associated with an RNA other than the RNA 235.

In some examples, a logical connection 230 may be established between two base stations 105 associated with cells in the RNA 235. For example, the logical connection 230 shown in FIG. 2 may connect cell 225-a of base station 105-a and cell 225-b of base station 105-b. The logical connection 230 may be used to convey AS and non-access stratum (NAS) signaling for UE 115-a. The logical connection 230 may be, for example, an Xn or X2 connection supporting a direct logical interface between cells 225, such that the base stations 105 may communicate directly via the logical connection 230 instead of through the core network 205. The logical connection 230 may be established over a direct physical connection between the base stations, or, via an indirect physical connection (e.g., switched or routed IP network connection). In some cases, the logical connection 230 to a cell 225 may be disconnected if the cell 225 leaves the RNA 235. Logical connections 230 may form a mesh network for each cell 225 associated with the RNA 235. Logical connections 230 may include a control-plane interface and a user-plane interface, which each may be implemented using a transmission protocol. The control-plane interface may, for example, employ a stream control transmission protocol (SCTP) while the user-plane interface may employ a general packet radio service (GPRS) tunneling protocol (GTP) and/or a user datagram protocol (UDP).

In some examples, paging for an inactive UE 115 may be handled by the RAN 240 instead of the core network 205. RAN paging may be initiated when downlink signaling or data arrives at base station 105-a. Base station 105-a may forward the paging information to each cell 225 of the RNA via logical connections 230. In some cases, the RAN 240 may not be aware of where UE 115-a is in the RNA 235 or on which cell 225 of RNA 235 UE 115-a is attached (e.g., camped on), so each cell 225 of RNA 235 may broadcast the paging message to page UE 115-a.

RAN-based paging may be performed using cell-specific RNAs, UE-specific RNAs, or a combination of cell-specific RNAs and UE-specific RNAs (e.g., a UE-specific RNA may be specified by a list of cell-specific RNAs or registration areas). The RAN 240 may dynamically update a list of cells, registration areas, or RNAs included in the RNA 235. The RAN 240 may update a UE-specific RNA 235 for UE 115-a by adding or removing cells, cell-specific RNAs, or registration areas. In some cases, the RAN 240 may update a cell-specific RNA by rearranging the cell attributes such that different cell-specific RNAs include different sets of cells. For example, a first cell-specific RNA and a second cell-specific RNA may each have two associated cells 225. In some cases, the first cell-specific RNA may be updated to include one of the cells 225 of the second cell-specific RNA. Therefore, the updated first cell-specific RNA may have three cells 225 and the second cell-specific RNA may have one cell 225. In another example, the first cell-specific RNA and the second cell-specific RNA may merge, combining the lists of cells 225 for both cell-specific RNAs to create a larger cell-specific RNA. Or, in some examples, a larger cell-specific RNA may be split into two cell-specific RNAs. By updating a cell-specific RNA, the rearrangement of the cell attributes may affect other UEs 115 in the RAN 240 (not shown).

In some cases, UE 115-a may transmit an autonomous RNA configuration (auto-RAC) report to a cell 225 of a base station 105 to which UE 115-a is attached. The auto-RAC report may include anchor base station information, a list of previously visited cells 225, and corresponding RNA information for each previously visited cell 225. UE 115-a may store connection history information and report mobility information and connection history information when queried by the RAN 240, when performing an RRC connection establishment procedure, when it reselects to a cell that does not provide the anchor base station 105 as a neighbor cell in system information, periodically, or when it reselects to a cell 225 of a new RNA. Base station 105-a may configure UE 115-a with an auto-RAC configuration prior to or while releasing UE 115-a to the inactive state. The auto-RAC configuration may indicate what to include in an auto-RAC report. For example, UE 115-a may include an ID of the anchor base station 105, IDs for the previously connected N cells (e.g., base station 105-a and base station 105-b), and the corresponding RNA IDs for each of the last N cells. The auto-RAC configuration may also include when to send an auto-RAC report, as described above.

As an example, if UE 115-a selects cell 225-c, which is not in RNA 235, the RAN 240 (e.g., base station 105-c) may decide whether to have cell 225-c join RNA 235 based on an auto-RAC report. UE 115-a may transmit an auto-RAC report to base station 105-c on cell 225-c during the RRC connection procedure. In some cases, base station 105-c may determine cell 225-c is likely to be frequently selected based on the auto-RAC indicating that RNA 235 includes nearby cells 225 and the mobility information of UE 115-a. If so, cell 225-c may join the RNA 235. In some examples, cell 225-c may be associated with a second RNA, and RNA 235 for UE 115-a may merge with the second RNA. If cell 225-c joins RNA 235, cell 225-c may establish logical connections 230 with the other cells 225 in RNA 235, and cell 225-c may be added to the list of cells in RNA 235. Thus, AS and NAS signaling may be conveyed by the logical connections 230 instead of repeatedly performing RRC connection registration. In some other examples, base station 105-c may determine cell 225-c would not be selected often for UE 115-a in inactive state, and cell 225-c may not join RNA 235.

In another example, UE 115-a may transmit an auto-RAC report when starting an RRC establishment procedure with a cell 225 in the RNA 235. For example, UE 115-a may start an RRC establishment procedure with cell 225-b of base station 105-b by transmitting an RRC resume request via cell 225-b to base station 105-b. If base station 105-b has logical connections established with base station 105-a in the RNA 235, base station 105-b may retrieve the UE context via the logical connections. In some other examples, logical connections may not be established, and base station 105-b may retrieve UE context via signaling from the core network 205. After retrieving UE context, base station 105-b may respond with an RRC resume message. If base station 105-b cannot retrieve UE context, base station 105-b may reply with an RRC connection setup on cell 225-b. UE 115-a may transmit an auto-RAC report with either an RRC resume complete message or an RRC connection setup complete message. Base station 105-b may identify the mobility information and connection history information of UE 115-a from the auto-RAC report. Based on the cell IDs and their corresponding RNA IDs in the connection history, base station 105-b may determine whether cell 225-b should remain in RNA 235 or be removed from RNA 235. Logical connections 230 may correspondingly be established or disconnected based on the determination. In some cases, base station 105-b may become the anchor base station 105 for UE 115-a after UE 115-a attaches.

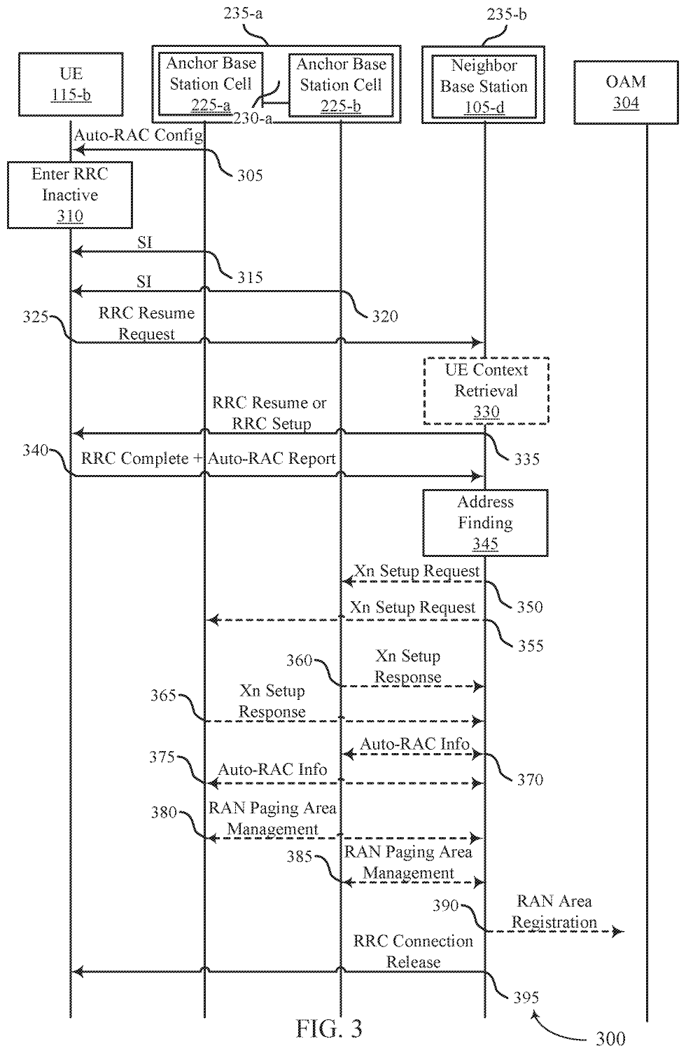

FIG. 3 illustrates an example of a process flow 300 that supports autonomous RAN notification area configuration in accordance with various aspects of the present disclosure. In some examples, process flow 300 may implement aspects of wireless communication system 100.

Process flow 300 may include UE 115-b, which may be an example of a UE 115 as described herein. Process flow 300 may further include cell 225-a and cell 225-b, which may be cells of a base station 105 as described herein. Cell 225-a and cell 225-b may be included in RNA 235-a. In some cases, cell 225-a and cell 225-b may have an established logical connection 230-a. A neighbor base station 105-d may be associated with a second RNA 235-b. Process flow 300 may further include an operations, administration, and management (OAM) 304. The OAM 304 may handle RNA registration. In some cases, the OAM 304 may be a part of one of the base stations 105, or the OAM may be a separate node within the RAN. The RAN may provide mobile connectivity for UE 115-b over a RAT via multiple access points, such as base stations 105 or cells 225 of the base stations 105, and interfaces with the core network for connectivity to IP-based or circuit-switched networks.

UE 115-b may initially be in an RRC connected state, attached to cell 225-a of the anchor base station 105. At 305, cell 225-a may release RRC connection with UE 115-b. The RAN may determine an auto-RAC configuration for UE 115-b and the anchor base station 105 may transmit the auto-RAC configuration via cell 225-a to UE 115-b during or prior to the RRC connection release. In some examples, the auto-RAC configuration may indicate what to include in an auto-RAC report. For example, the auto-RAC configuration may indicate to UE 115-b to include the anchor base station 105, IDs for the previous N cells, and the corresponding RNA ID for each of the cells. The auto-RAC configuration may also include when to report. For example, UE 115-b may transmit auto-RAC reports based on an event trigger such as when UE 115-b moves to a new RNA 235, during cell reselection if the anchor cell is not provided as a neighbor in a system information broadcast of the reselected cell, upon starting an RRC establishment procedure, or when requested to by the RAN. Additionally or alternatively, UE 115-b may periodically transmit an auto-RAC report to the cell which UE 115-b is attached to.

At 310, UE 115-b may transition to the inactive state. UE 115-b may identify an RNA 235 configured for the inactive state including at least cell 225-a and cell 225-b. In inactive state, UE 115-b may be able to move in the RNA 235 without notifying the RAN. UE 115-b may follow some idle state cell reselection behavior within RNA 235-a, such as reading system information broadcasts, while appearing to a core network as still being connected to the RAN. At 315 and 320, UE 115-b may read system information broadcasts from cell 225-a and cell 225-b respectively and store the cell ID and corresponding RNA ID. In some examples, UE 115-b may move near another RNA, such as RNA 235-b associated with cells 225 of neighbor base station 105-d.

At 325, UE 115-b may reselect, in the inactive state and independently of (e.g., without any messaging or notification) the cell 225-a or cell 225-b, to a cell of base station 105-d. UE 115-b may transmit an RRC resume request to base station 105-d. UE 115-b may be in a new RNA 235 when transmitting the RRC resume request, and UE 115-b may transmit the RRC resume request to update its RNA 235. UE 115-b may receive system information broadcasts from base station 105-d and determine whether it's in a new RNA 235 based on the received system information.

Base station 105-d may determine if there are logical connections established with the RNA 235-a at 330. If there is a connection (e.g., an Xn or X2 connection), base station 105-d may request UE context from the anchor base station 105 via the logical connection. If there are not Xn connections, base station 105-d may request UE context from the core network. After receiving UE context, base station 105-d may respond with an RRC resume message. Otherwise, base station 105-d may perform an RRC connection setup procedure. At 335, base station 105-d may transmit an RRC resume message based on the UE context. If base station 105-d could not obtain UE context, base station 105-d may fallback to an RRC connection setup and transmit an RRC setup message.

Upon receipt of the RRC resume message or RRC connection setup, UE 115-b may transition to an RRC connected state. At 340, UE 115-b may transmit an RRC resume complete message, or an RRC connection setup complete message, to base station 105-d. UE 115-b may include an auto-RAC report with the message. The auto-RAC report may include cell IDs of cells in the connection history of UE 115-b as well as the corresponding RNA IDs. For example, the connection history of UE 115-b may include cell 225-a and cell 225-b, as well as an RNA ID for RNA 235-a. The auto-RAC report may include further mobility information for UE 115-b. For example, the last N cells for which UE 115-b was attached may include cells that UE 115-b reselected to while in the inactive state, connected to in a connected state, or reselected to in an idle state. At 345, base station 105-d may find transport network layer (TNL) addresses of the cells 225 indicated in the auto-RAC report.

If base station 105-d does not have logical connections established with base stations 105 indicated in the auto-RAC report, base station 105-d may request a logical connection setup with cell 225-b and cell 225-a at 350 and 355 respectively. Cell 225-a and cell 225-b may reply with logical connection setup responses at 360 and 365 respectively.

At 370 and 375, base station 105-d may exchange RNA information with cell 225-a and cell 225-b related to RNA 235-a and RNA 235-b. Base station 105-d may exchange RNA information with each cell 225 included in the connection history of the auto-RAC report. The RNA information may be used to generate another auto-RAC configuration and RNA 235 for UE 115-b when UE 115-b enters an inactive state. In some cases, the RNA information may be exchanged via the logical connections. If logical connections were not established, the RNA information may be exchanged by indirect communication via intermediate node routing.

At 380 and 385, the RAN may perform RAN paging area management. For example, the RAN may decide whether base station 105-d joins RNA 235-a, or whether to merge RNA 235-a and RNA 235-b. The determination may be made on the contents of the auto-RAC report. For example, if base station 105-d determines that UE 115-b may frequently reselect to base station 105-d from cells 225 of RNA 235-a, base station 105-d may join RNA 235-a to reduce the number of RRC registrations that UE 115-b may perform with base station 105-d. Base station 105-d may have set up logical connections 230 with the other base stations associated with RNA 235-a based on the auto-RAC report, and base station 105-d may retrieve UE context and RRC information via logical connections 230 instead of requesting UE context from the core network. As described, the RAN may decide to associate or disassociate a cell 225 with an RNA 235 independent from the core network (e.g., RNAs 235 may be managed by base stations 105 and OAM 304, independently of the AMF and/or UPF). In some examples, the determination of whether to associate a cell with an RNA 235 or disassociate the cell with the RNA 235 may be made based on auto-RAC reports from other UEs 115 as well. At 390, base station 105-d may register the new, expanded or merged RNA 235 with the OAM 304.

In some cases, RNA 235-a may be specific to UE 115-b. In some cases, a cell 225 of base station 105-d may be added to the UE-specific RNA 235-a. Therefore, UE 115-b can move in the cell-specific RNA 235-a including the cell of base station 105-d without notifying the RAN. This may not affect another UE 115 with a UE-specific RNA 235-b, as only the UE-specific RNA 235-a is updated.

In another example, RNA 235-a and RNA 235-b may each be cell-specific RNAs. RNA management may include merging the cell-specific RNAs 235-a and 235-b. Thus, RNA 235-a and RNA 235-b may combine to create a larger RNA 235 which includes the cells of RNA 235-a and RNA 235-b. Alternatively, a cell in RNA 235-b may be moved from RNA 235-b to RNA 235-a. In some cases, changing a cell-specific RNA may affect each UE-specific RNA with one or more cells in the changed cell-specific RNA. For example, UE 115-b may have a UE-specific RNA that includes RNA 235-a, and if RNA 235-a is expanded by adding cells or merging with another cell-specific RNA 235, then the UE-specific RNA is similarly expanded. In addition, another UE 115 (not shown) with a UE-specific RNA which previously included just RNA 235-b would now also include RNA 235-a if RNA 235-a and RNA 235-b merge.

When UE 115-b is released to the inactive state at 395 by base station 105-d, a new RNA list may be configured for UE 115-b. For example, the new RNA list may be configured based on the merged RNA 235, the RNA information exchanged at 370 and 375, and the RNA paging area management information exchanged at 380 and 385. Base station 105-d may transmit an RRC connection release to UE 115-b to release UE 115-b to the inactive state. Base station 105-d may include the updated RNA list in an updated auto-RAC configuration and transmit the updated auto-RAC configuration while or prior to releasing UE 115-b to the inactive state.

As described, an auto-RAC reporting procedure may be used to autonomously redesign an RNA area based on an inactive UE 115 reporting connection history information, including the anchor cell, the previous N cells to which the UE 115 connected, as well as RNA IDs for each of the previously connected N cells. Based on the auto-RAC procedure, small RNAs may be merged to create a larger RNA or to reconfigure a new RNA list for the UE 115 based on the UE's mobility history to reduce RNA update signaling costs. Logical connections may be automatically set up based on the auto-RAC report.

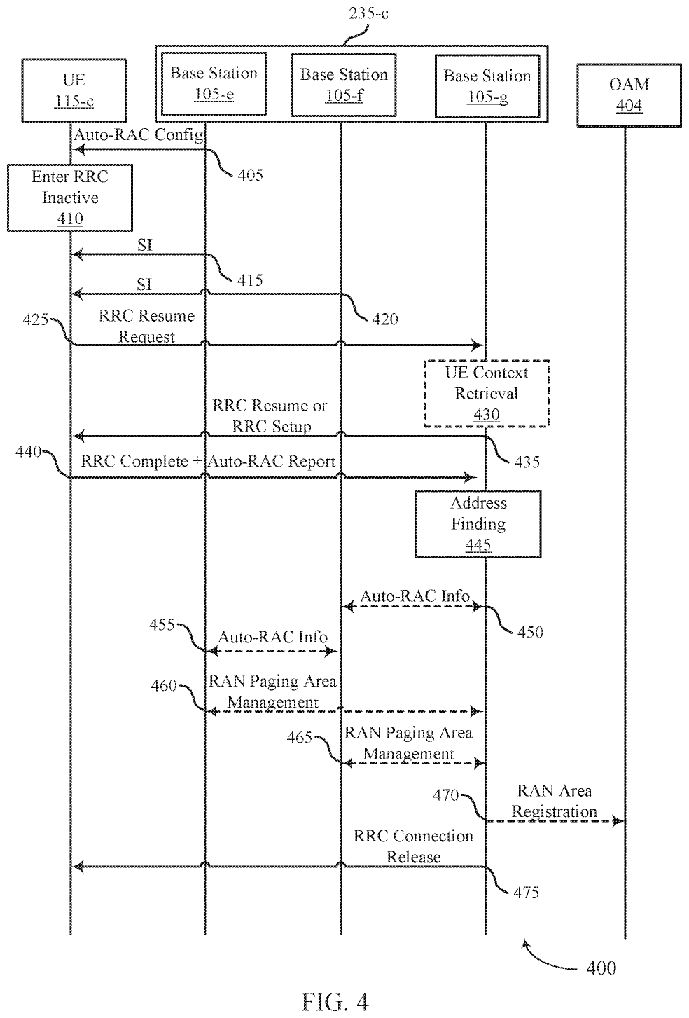

FIG. 4 illustrates an example of a process flow 400 that supports autonomous RAN notification area configuration in accordance with various aspects of the present disclosure. In some examples, process flow 400 may implement aspects of wireless communication system 100.

Process flow 400 may include UE 115-c, which may be an example of a UE 115 as described herein. Process flow 400 may further include base station 105-e, which may be the anchor base station 105 for UE 115-c in the inactive state, base station 105-f, and base station 105-g, each of which may be included in RNA 235-c. In some cases, none of the base stations 105 may have logical connections, or Xn connections, established. Process flow 400 may further include an OAM 404. The OAM 404 may handle RAN area registration.

UE 115-c may initially be in an RRC connected state, connected to base station 105-e. At 405, base station 105-e may release RRC connection with UE 115-c. Base station 105-e may configure auto-RAC information for UE 115-c and transmit the auto-RAC configuration to UE 115-c at 405 during or prior to the RRC connection release. In some examples, the auto-RAC configuration may indicate what to include in an auto-RAC report. For example, the auto-RAC configuration may indicate to include the anchor base station 105, IDs for the previously connected N cells (e.g., of base station 105-e, base station 105-f, and base station 105-g), and the corresponding RNA IDs for each of the last N cells. The auto-RAC configuration may also include when to transmit an auto-RAC report. For example, UE 115-c may transmit auto-RAC reports based on an event trigger such as when UE 115-c moves to a new RAN area. In some other examples, UE 115-c may report auto-RAC on cell reselection if the anchor cell is not provided as a neighbor in a system information broadcast of the new, selected cell. In some cases, UE 115-c may transmit an auto-RAC report upon starting an RRC establishment procedure. In some other examples, UE 115-c may send an auto-RAC report upon request by the RAN. Additionally or alternatively, UE 115-c may periodically transmit an auto-RAC report to the cell UE 115-c is attached to.

At 410, UE 115-c may transition to the inactive state. UE 115-b may identify an RNA configured for the inactive state including at least base station 105-e, base station 105-f, and base station 105-g. In the inactive state, UE 115-c may be able to move in the RNA 235-c without notifying the RAN. UE 115-c may follow some idle state cell reselection behavior within the RNA 235-c, such as reading system information broadcasts, while appearing to a core network as still being connected to the RAN. At 415 and 420, UE 115-c may read system information broadcasts from base station 105-e and base station 105-f respectively and store the cell ID and corresponding RNA 235.

At 425, UE 115-c may reselect, in the inactive state and independently of base station 105-e or base station 105-f, to a cell of base station 105-g. UE 115-c may transmit an RRC resume request to base station 105-g. In some cases, UE 115-c may initiate the RRC resume procedure to transmit mobile originated data, based on a received page, a timer for periodic auto-RAC reporting, or in response to a request to transmit an auto-RAC report. UE 115-c may be in the same RNA when transmitting the RRC resume request, which may be determined based on receiving system information broadcasts.

Base station 105-g may determine if there are logical connections established with the anchor base station 105 (e.g., base station 105-e). If there is an existing logical connection, base station 105-g may request UE context from the anchor base station 105 via the logical connection and perform an RRC resume procedure. If there is not a logical connection, base station 105-g may request UE context for UE 115-c from the core network. If base station 105-g retrieves the UE context, base station 105-g may transmit an RRC resume message at 435. If base station 105-g was unable to retrieve UE context, base station 105-g may transmit an RRC setup message.

Upon receipt of the setup or resume message, UE 115-c may transition to a connected state with base station 105-g. At 440, UE 115-c may transmit an RRC resume complete message, or an RRC connection setup complete message, to base station 105-g with an auto-RAC report. The auto-RAC report may include cell IDs of cells in the connection history of UE 115-c as well as the corresponding RNA IDs. For example, the connection history of UE 115-c may include base station 105-e and base station 105-f, as well as an RNA ID for RNA 235-c. The auto-RAC report may further include information related to mobility of UE 115-c (e.g., mobility in any combination of the inactive state, connected state, or idle state). At 445, base station 105-g may identify TNL addresses of base station 105-e and base station 105-f.

At 450 and 455, base station 105-g may exchange RNA information with base station 105-e and base station 105-f. In some examples, base station 105-g may exchange RNA information with each RNA included in the connection history of the auto-RAC report. The RNA information may be used to generate another auto-RAC configuration and RNA list for UE 115-c. If logical connections were not set up between the base stations 105, the RNA information may be exchanged by indirect communication via intermediate node routing (e.g., via OAM 404).

At 460 and 465, the RAN may perform RAN paging area management. For example, the RAN may determine to split RNA 235-c into two smaller RNAs 235. The determination may be made on the contents of the auto-RAC report. Base station 105-g may determine that UE 115-c may not frequently attach, and base station 105-g may split into a separate RNA 235. Therefore, the RAN may free up a logical connection by removing base station 105-g from the RNA list of UE 115-c. In some other examples, if base station 105-g determines that UE 115-c may frequently request to attach, base station 105-g may stay in RNA 235-c, for example as described with reference to FIG. 3. At 470, base station 105-g may register the two RNAs created by splitting RNA 235-c to the OAM 404.

When UE 115-c is released to the inactive state at 475 by base station 105-g, a new RNA list may be configured for UE 115-c. For example, the new RNA list may be configured based on the RNA associated with base station 105-g. In some examples, the new RNA list for UE 15-c may not include base station 105-e and base station 105-f. The RNA list may be based on the RNA information exchanged at 460 and 465. Base station 105-g may transmit an RRC connection release to UE 115-c to release UE 115-c to the inactive state.

As described, auto-RAC procedures may be used to autonomously redesign an RNA based on an inactive UE 115 reporting connection history information, including the anchor cell, the previous N cells to which the UE 115 connected, as well as RNA IDs for each of the previously connected N cells. In this example, the RNA initially configured for the inactive UE 115 may be split into smaller RAN areas. The RNA 235 may be defined with a registration area, without consideration of whether logical connections are present between each of the base stations 105. An RNA 235 may be initially defined by a registration area, which may not initially include logical connections between cells 225 or base stations 105 in the registration area. Thus, the RNA 235-c of FIG. 4 may be a large, initially defined registration area which may be split into smaller RNAs 235 as the RAN determines which cells of RNA 235-c UE 115-c is likely to attach to. The RAN may also merge or divide RNAs 235 based on whether logical connections between cells of the RNAs 235 can be established.

When downlink data arrives at the anchor base station 105 for paging, the RAN paging may be limited within the anchor base station 105 due to a lack of logical connections to other base stations 105 or due to paging only being performed in the RNA 235. In this case, the UE 115 may be under another base station 105 than the anchor base station 105, and RAN paging may fail due to not receiving a response from the UE 115. In some cases, anchor base station 105 may release connection with the UE 115 and core network paging may be triggered.

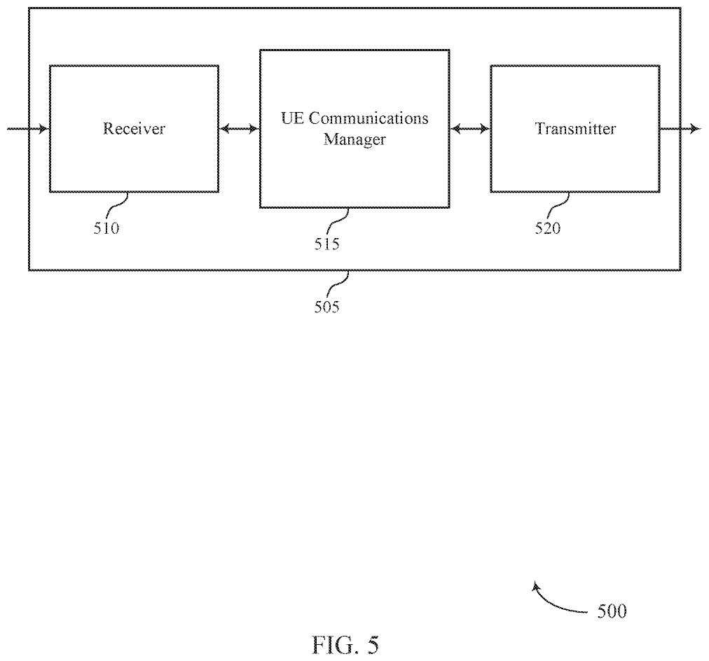

FIG. 5 shows a block diagram 500 of a wireless device 505 that supports autonomous RAN notification area configuration in accordance with aspects of the present disclosure. Wireless device 505 may be an example of aspects of a UE 115 as described herein. Wireless device 505 may include receiver 510, UE communications manager 515, and transmitter 520. Wireless device 505 may also include a processor. Each of these components may be in communication with one another (e.g., via one or more buses).

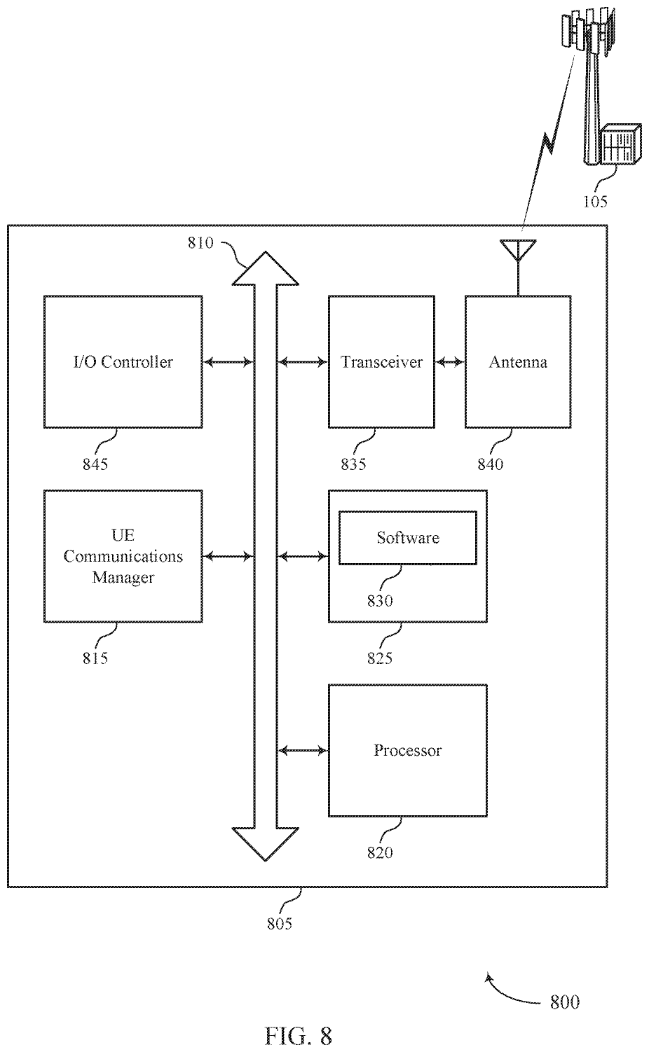

Receiver 510 may receive information such as packets, user data, or control information associated with various information channels (e.g., control channels, data channels, and information related to autonomous RAN notification area configuration, etc.). Information may be passed on to other components of the device. The receiver 510 may be an example of aspects of the transceiver 835 described with reference to FIG. 8. The receiver 510 may utilize a single antenna or a set of antennas.

UE communications manager 515 may be an example of aspects of the UE communications manager 815 described with reference to FIG. 8.

UE communications manager 515 and/or at least some of its various sub-components may be implemented in hardware, software executed by a processor, firmware, or any combination thereof. If implemented in software executed by a processor, the functions of the UE communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The UE communications manager 515 and/or at least some of its various sub-components may be physically located at various positions, including being distributed such that portions of functions are implemented at different physical locations by one or more physical devices. In some examples, UE communications manager 515 and/or at least some of its various sub-components may be a separate and distinct component in accordance with various aspects of the present disclosure. In other examples, UE communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 515 may transition, at a UE, from a connected state with a first cell to an inactive state, identify a notification area configured for the inactive state including at least the first cell, reselect, while in the inactive state and independently of the first cell, to a second cell, identify, while in the inactive state, a trigger for reporting mobility history information, and report the mobility history information based on the trigger, the mobility history information including a set of cells to which the UE has previously attached and corresponding notification areas for each of the set of cells.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

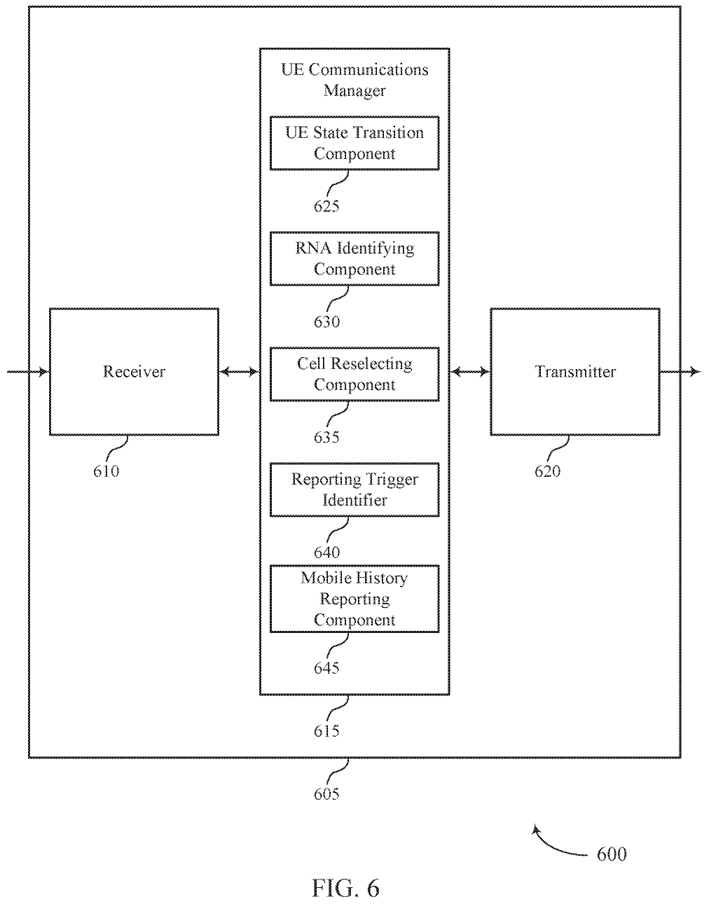

FIG. 6 shows a block diagram 600 of a wireless device 605 that supports autonomous RAN notification area configuration in accordance with aspects of the present disclosure. Wireless device 605 may be an example of aspects of a wireless device 505 or a UE 115 as described with reference to FIG. 5. Wireless device 605 may include receiver 610, UE communications manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to autonomous RAN notification area configuration, etc.). Information may be passed on to other components of the device. The receiver 610 may be an example of aspects of the transceiver 835 described with reference to FIG. 8. The receiver 610 may utilize a single antenna or a set of antennas.

UE communications manager 615 may be an example of aspects of the UE communications manager 815 described with reference to FIG. 8.

UE communications manager 615 may also include UE state transition component 625, RNA identifying component 630, cell reselecting component 635, reporting trigger identifier 640, and mobile history reporting component 645.

UE state transition component 625 may transition, at a UE, from a connected state with a first cell to an inactive state. The UE state transition component 625 may also, in the inactive state, maintain an access stratum context associated with a session connection and is configured for autonomous cell reselection. In some cases, in the inactive state, the UE may maintain an access stratum context associated with a session connection and may be configured for autonomous cell reselection.

RNA identifying component 630 may identify a notification area configured for the inactive state including at least the first cell.

Cell reselecting component 635 may reselect, while in the inactive state and independently of the first cell, to a second cell.

Reporting trigger identifier 640 may identify, while in the inactive state, a trigger for reporting mobility history information. In some cases, identifying the trigger for reporting mobility history information includes identifying that the second cell is not within the notification area. In some cases, identifying the trigger for reporting mobility history information includes identifying, upon the reselecting to the second cell, that a neighbor list for the second cell excludes the first cell. In some examples, identifying the trigger for reporting mobility history information includes performing a connection setup procedure or a connection resume procedure. In some cases, identifying the trigger for reporting mobility history information includes receiving a request for the mobility history information. In some cases, identifying the trigger for reporting mobility history information is based at least in part on expiration of a timer associated with periodic reporting of the mobility history information.

Mobile history reporting component 645 may report the mobility history information based on the trigger, the mobility history information including a set of cells to which the UE has previously attached and corresponding notification areas for each of the set of cells and report the mobility history information includes reporting the mobility history information to the second cell as part of a connection setup procedure, a connection resume procedure, or a notification area update procedure. In some cases, the set of cells includes a predetermined number of cells.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may utilize a single antenna or a set of antennas.

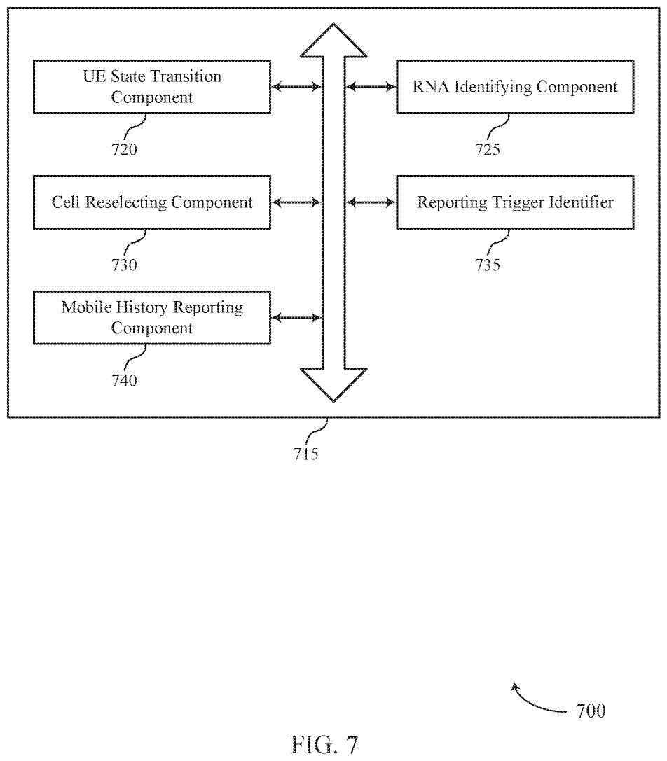

FIG. 7 shows a block diagram 700 of a UE communications manager 715 that supports autonomous RAN notification area configuration in accordance with aspects of the present disclosure. The UE communications manager 715 may be an example of aspects of a UE communications manager 515, a UE communications manager 615, or a UE communications manager 815 described with reference to FIGS. 5, 6, and 8. The UE communications manager 715 may include UE state transition component 720, RNA identifying component 725, cell reselecting component 730, reporting trigger identifier 735, and mobile history reporting component 740. Each of these modules may communicate, directly or indirectly, with one another (e.g., via one or more buses).

UE state transition component 720 may transition, at a UE, from a connected state with a first cell to an inactive state. The UE state transition component 720 may also, in the inactive state, maintain an access stratum context associated with a session connection and is configured for autonomous cell reselection. In some cases, in the inactive state, the UE may maintain an access stratum context associated with a session connection and may be configured for autonomous cell reselection.

RNA identifying component 725 may identify a notification area configured for the inactive state including at least the first cell. Cell reselecting component 730 may reselect, while in the inactive state and independently of the first cell, to a second cell.

Reporting trigger identifier 735 may identify, while in the inactive state, a trigger for reporting mobility history information. In some cases, identifying the trigger for reporting mobility history information includes identifying that the second cell is not within the notification area. In some cases, identifying the trigger for reporting mobility history information includes: identifying, upon the reselecting to the second cell, that a neighbor list for the second cell excludes the first cell. In some cases, identifying the trigger for reporting mobility history information includes performing a connection setup procedure or a connection resume procedure. In some cases, identifying the trigger for reporting mobility history information includes receiving a request for the mobility history information. In some cases, identifying the trigger for reporting mobility history information is based at least in part on expiration of a timer associated with periodic reporting of the mobility history information.

Mobile history reporting component 740 may report the mobility history information based on the trigger, the mobility history information including a set of cells to which the UE has previously attached and corresponding notification areas for each of the set of cells and report the mobility history information includes reporting the mobility history information to the second cell as part of a connection setup procedure, a connection resume procedure, or a notification area update procedure. In some cases, the set of cells includes a predetermined number of cells.

FIG. 8 shows a diagram of a system 800 including a device 805 that supports autonomous RAN notification area configuration in accordance with aspects of the present disclosure. Device 805 may be an example of or include the components of wireless device 505, wireless device 605, or a UE 115 as described above, e.g., with reference to FIGS. 5 and 6. Device 805 may include components for bi-directional voice and data communications including components for transmitting and receiving communications, including UE communications manager 815, processor 820, memory 825, software 830, transceiver 835, antenna 840, and I/O controller 845. These components may be in electronic communication via one or more buses (e.g., bus 810). Device 805 may communicate wirelessly with one or more base stations 105.

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting autonomous RAN notification area configuration).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware or software operation such as the interaction with peripheral components or devices.

Software 830 may include code to implement aspects of the present disclosure, including code to support autonomous RAN notification area configuration. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

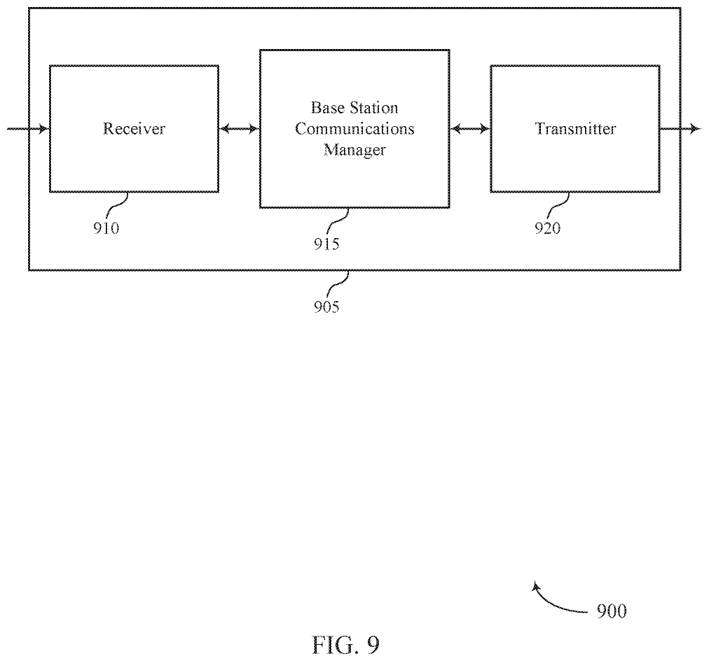

FIG. 9 shows a block diagram 900 of a wireless device 905 that supports autonomous RAN notification area configuration in accordance with aspects of the present disclosure. Wireless device 905 may be an example of aspects of a base station 105 as described herein. Wireless device 905 may include receiver 910, base station communications manager 915, and transmitter 920. Wireless device 905 may also include a processor. Each of these components may be in communication with one another (e.g., via one or more buses).

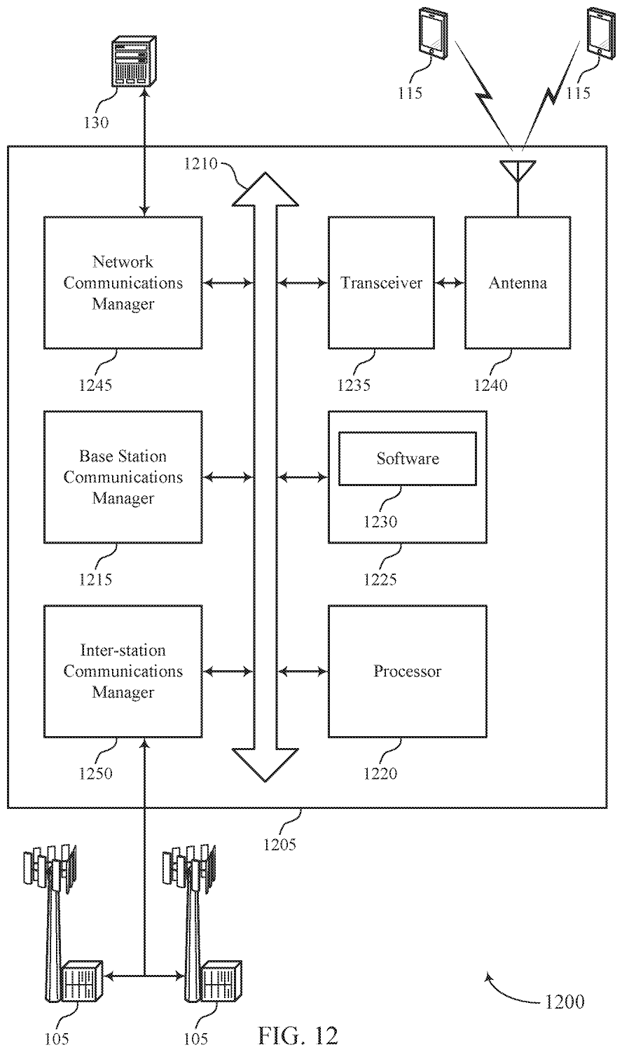

Receiver 910 may receive information such as packets, user data, or control information associated with various information channels (e.g., control channels, data channels, and information related to autonomous RAN notification area configuration, etc.). Information may be passed on to other components of the device. The receiver 910 may be an example of aspects of the transceiver 1235 described with reference to FIG. 12. The receiver 910 may utilize a single antenna or a set of antennas. Base station communications manager 915 may be an example of aspects of the base station communications manager 1215 described with reference to FIG. 12.

Base station communications manager 915 and/or at least some of its various sub-components may be implemented in hardware, software executed by a processor, firmware, or any combination thereof. If implemented in software executed by a processor, the functions of the base station communications manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The base station communications manager 915 and/or at least some of its various sub-components may be physically located at various positions, including being distributed such that portions of functions are implemented at different physical locations by one or more physical devices. In some examples, base station communications manager 915 and/or at least some of its various sub-components may be a separate and distinct component in accordance with various aspects of the present disclosure. In other examples, base station communications manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Base station communications manager 915 may receive, by a base station associated with a second cell, mobility history information from a UE via the second cell, the mobility history information including a set of cells to which the UE has previously attached and corresponding notification areas for each of the set of cells, the UE having reselected to the second cell in an inactive state, identify, based on the mobility history information, that a first cell is an anchor cell for the UE and a notification area corresponding to the first cell for the UE, and determine, based on the mobility history information, whether to associate or disassociate the second cell with the notification area.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may utilize a single antenna or a set of antennas.

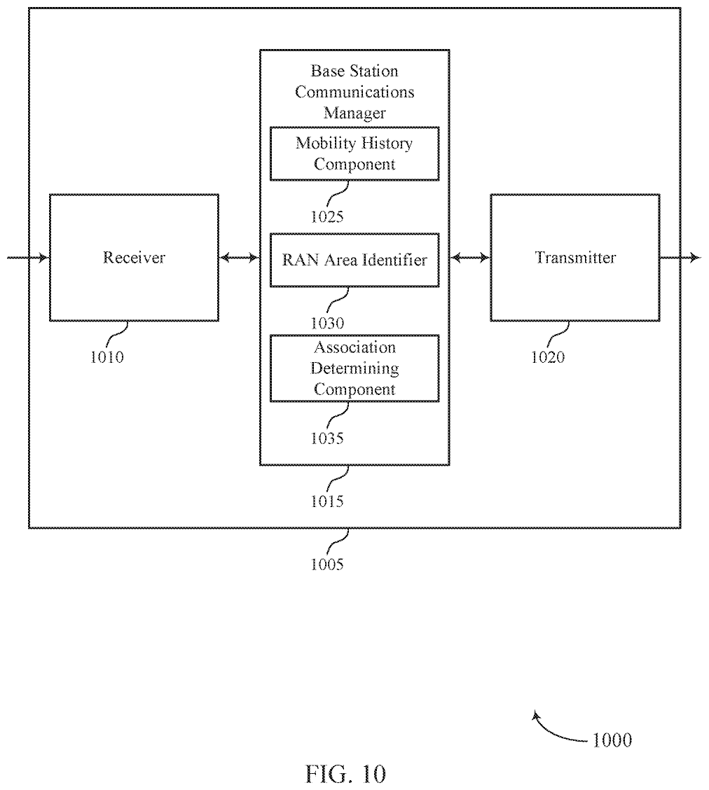

FIG. 10 shows a block diagram 1000 of a wireless device 1005 that supports autonomous RAN notification area configuration in accordance with aspects of the present disclosure. Wireless device 1005 may be an example of aspects of a wireless device 905 or a base station 105 as described with reference to FIG. 9. Wireless device 1005 may include receiver 1010, base station communications manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to autonomous RAN notification area configuration, etc.). Information may be passed on to other components of the device. The receiver 1010 may be an example of aspects of the transceiver 1235 described with reference to FIG. 12. The receiver 1010 may utilize a single antenna or a set of antennas.

Base station communications manager 1015 may be an example of aspects of the base station communications manager 1215 described with reference to FIG. 12. Base station communications manager 1015 may also include mobility history component 1025, RAN area identifier 1030, and association determining component 1035.

Mobility history component 1025 may receive, by a base station associated with a second cell, mobility history information from a UE via the second cell, the mobility history information including a set of cells to which the UE has previously attached and corresponding notification areas for each of the set of cells, the UE having reselected to the second cell in an inactive state.

RAN area identifier 1030 may identify, based on the mobility history information, that a first cell is an anchor cell for the UE and a notification area corresponding to the first cell for the UE.

Association determining component 1035 may determine, based on the mobility history information, whether to associate or disassociate the second cell with the notification area. The association determining component 1035 may also perform a notification area registration to associate the second cell with the notification area for the UE, receive a setup response indicating a failure to setup the logical connection between the first cell and the second cell, determine to refrain from associating the second cell with the notification area for the UE, and perform a notification area registration to disassociate the second cell from the notification area for the UE. In some cases, the second cell may not be associated with the notification area upon receiving the mobility history information for the UE, and association determining component 1035 may also send a setup request for a logical connection between the first cell and the second cell. In some cases, the second cell is associated with the notification area upon receiving the mobility history information for the UE, and where the determining includes determining to disassociate the second cell with the notification area for the UE based on the mobility history information. In some cases, the second cell may be associated with a second, different notification area upon receiving the mobility history information for the UE, and association determining component 1035 may determine to merge the second notification area with the notification area.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

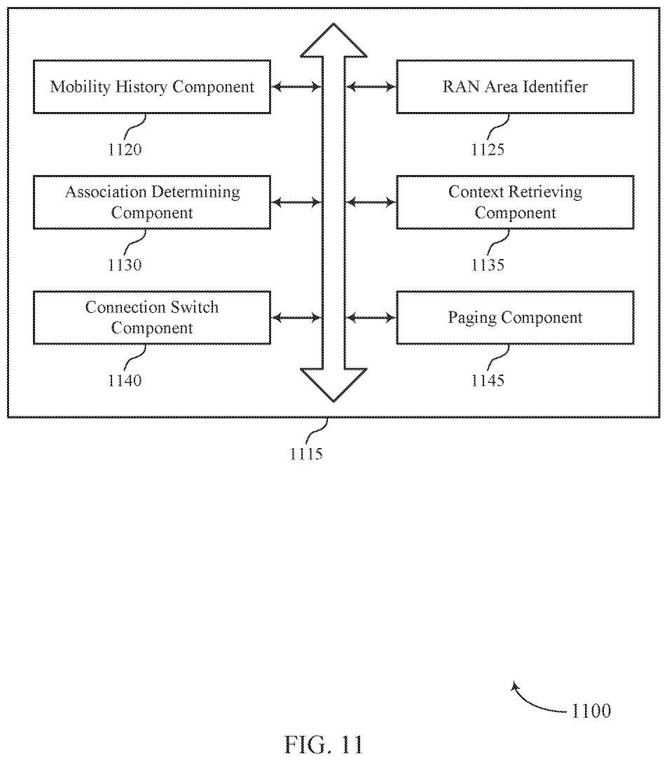

FIG. 11 shows a block diagram 1100 of a base station communications manager 1115 that supports autonomous RAN notification area configuration in accordance with aspects of the present disclosure. The base station communications manager 1115 may be an example of aspects of a base station communications manager 1215 described with reference to FIGS. 9, 10, and 12. The base station communications manager 1115 may include mobility history component 1120, RAN area identifier 1125, association determining component 1130, context retrieving component 1135, connection switch component 1140, and paging component 1145. Each of these modules may communicate, directly or indirectly, with one another (e.g., via one or more buses).

Mobility history component 1120 may receive, by a base station associated with the second cell, mobility history information from a UE via the second cell, the mobility history information including a set of cells to which the UE has previously attached and corresponding notification areas for each of the set of cells, the UE having reselected to the second cell in an inactive state.

RAN area identifier 1125 may identify, based on the mobility history information, that the first cell is an anchor cell for the UE and a notification area corresponding to the first cell for the UE.

Association determining component 1130 may determine, based on the mobility history information, whether to associate or disassociate the second cell with the notification area. The association determining component 1130 may also perform a notification area registration to associate the second cell with the notification area for the UE, receive a setup response indicating a failure to setup the logical connection between the first cell and the second cell, determine to refrain from associating the second cell with the notification area for the UE, and perform a notification area registration to disassociate the second cell from the notification area for the UE. The association determining component 1130 may also send a setup request for a logical connection between the first cell and the second cell. In some cases, the second cell is associated with the notification area upon receiving the mobility history information for the UE, and where the determining includes determining to disassociate the second cell with the notification area for the UE based on the mobility history information. In some cases, the second cell may be associated with a second, different notification area upon receiving the mobility history information for the UE, and association determining component 1130 may determine to merge the second notification area with the notification area.

Context retrieving component 1135 may retrieve a context for the UE from the first cell. Connection switch component 1140 may perform a connection switch procedure to switch a session connection for the UE from the first cell to the second cell. Paging component 1145 may receive, from a core network, downlink data traffic for the UE and send, via the logical connection, a paging request to the first cell to page the UE via the first cell.

FIG. 12 shows a diagram of a system 1200 including a device 1205 that supports autonomous RAN notification area configuration in accordance with aspects of the present disclosure. Device 1205 may be an example of or include the components of base station 105 as described above, e.g., with reference to FIG. 1. Device 1205 may include components for bi-directional voice and data communications including components for transmitting and receiving communications, including base station communications manager 1215, processor 1220, memory 1225, software 1230, transceiver 1235, antenna 1240, network communications manager 1245, and inter-station communications manager 1250. These components may be in electronic communication via one or more buses (e.g., bus 1210). Device 1205 may communicate wirelessly with one or more UEs 115.

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting autonomous RAN notification area configuration).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware or software operation such as the interaction with peripheral components or devices.

Software 1230 may include code to implement aspects of the present disclosure, including code to support autonomous RAN notification area configuration. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

Network communications manager 1245 may manage communications with the core network (e.g., via one or more wired backhaul links). For example, the network communications manager 1245 may manage the transfer of data communications for client devices, such as one or more UEs 115.

Inter-station communications manager 1250 may manage communications with other base station 105, and may include a controller or scheduler for controlling communications with UEs 115 in cooperation with other base stations 105. For example, the inter-station communications manager 1250 may coordinate scheduling for transmissions to UEs 115 for various interference mitigation techniques such as beamforming or joint transmission. In some examples, inter-station communications manager 1250 may provide an X2 interface within an Long Term Evolution (LTE)/LTE-A wireless communication network technology to provide communication between base stations 105.

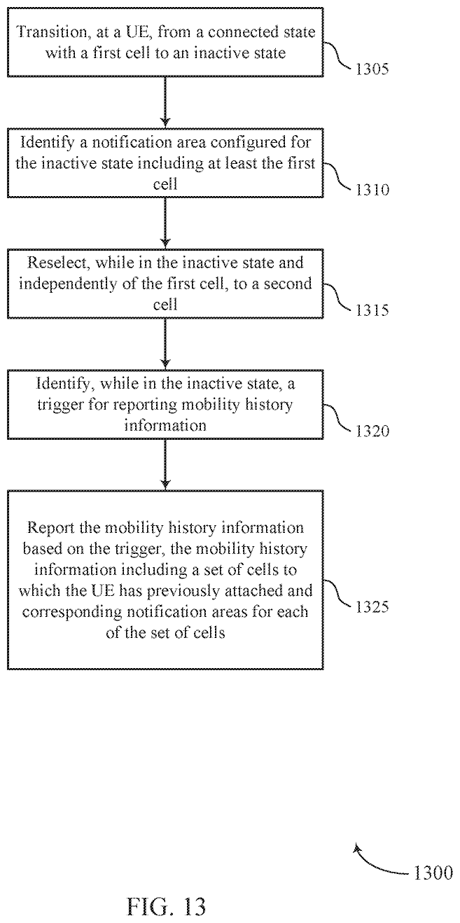

FIG. 13 shows a flowchart illustrating a method 1300 for autonomous RAN notification area configuration in accordance with aspects of the present disclosure. The operations of method 1300 may be implemented by a UE 115 or its components as described herein. For example, the operations of method 1300 may be performed by a UE communications manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At 1305 the UE 115 may transition from a connected state with a first cell to an inactive state. The operations of 1305 may be performed according to the methods described herein. In certain examples, aspects of the operations of 1305 may be performed by a UE state transition component as described with reference to FIGS. 5 through 8.

At 1310 the UE 115 may identify a notification area configured for the inactive state comprising at least the first cell. The operations of 1310 may be performed according to the methods described herein. In certain examples, aspects of the operations of 1310 may be performed by a RNA identifying component as described with reference to FIGS. 5 through 8.

At 1315 the UE 115 may reselect, while in the inactive state and independently of the first cell, to a second cell. The operations of 1315 may be performed according to the methods described herein. In certain examples, aspects of the operations of 1315 may be performed by a cell reselecting component as described with reference to FIGS. 5 through 8.

At 1320 the UE 115 may identify, while in the inactive state, a trigger for reporting mobility history information. The operations of 1320 may be performed according to the methods described herein. In certain examples, aspects of the operations of 1320 may be performed by a reporting trigger identifier as described with reference to FIGS. 5 through 8.

At 1325 the UE 115 may report the mobility history information based at least in part on the trigger, the mobility history information comprising a plurality of cells to which the UE has previously attached and corresponding notification areas for each of the plurality of cells. The operations of 1325 may be performed according to the methods described herein. In certain examples, aspects of the operations of 1325 may be performed by a mobile history reporting component as described with reference to FIGS. 5 through 8.

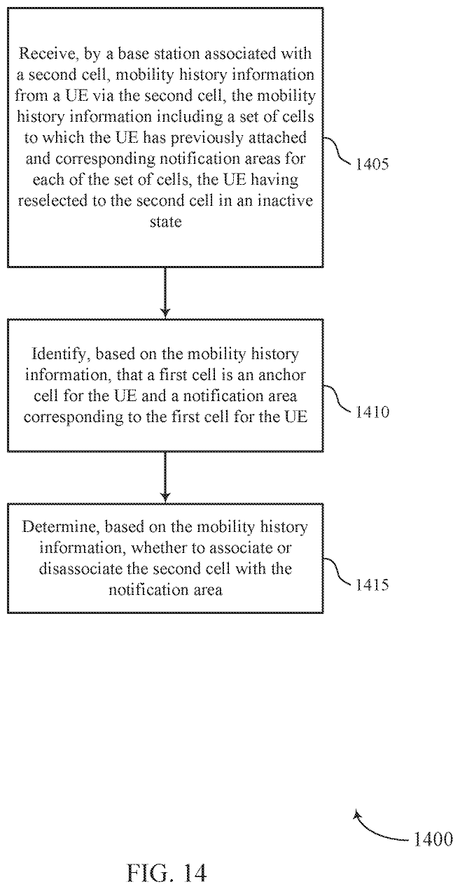

FIG. 14 shows a flowchart illustrating a method 1400 for autonomous RAN notification area configuration in accordance with aspects of the present disclosure. The operations of method 1400 may be implemented by a base station 105 or its components as described herein. For example, the operations of method 1400 may be performed by a base station communications manager as described with reference to FIGS. 9 through 12. In some examples, a base station 105 may execute a set of codes to control the functional elements of the device to perform the functions described below. Additionally or alternatively, the base station 105 may perform aspects of the functions described below using special-purpose hardware.

At 1405 the base station 105, associated with the second cell, may receive mobility history information from a UE via the second cell, the mobility history information comprising a plurality of cells to which the UE has previously attached and corresponding notification areas for each of the plurality of cells, the UE having reselected to the second cell in an inactive state. The operations of 1405 may be performed according to the methods described herein. In certain examples, aspects of the operations of 1405 may be performed by a mobility history component as described with reference to FIGS. 9 through 12.

At 1410 the base station 105 may identify, based at least in part on the mobility history information, that the first cell is an anchor cell for the UE and a notification area corresponding to the first cell for the UE. The operations of 1410 may be performed according to the methods described herein. In certain examples, aspects of the operations of 1410 may be performed by a RAN area identifier as described with reference to FIGS. 9 through 12.

At 1415 the base station 105 may determine, based at least in part on the mobility history information, whether to associate or disassociate the second cell with the notification area. The operations of 1415 may be performed according to the methods described herein. In certain examples, aspects of the operations of 1415 may be performed by an association determining component as described with reference to FIGS. 9 through 12.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
transitioning, at a user equipment (UE), from a connected state with a first cell to an inactive state;
identifying a notification area configured for the inactive state comprising at least the first cell;
reselecting, while in the inactive state and independently of the first cell, to a second cell;
identifying, while in the inactive state, a trigger for reporting mobility history information; and
reporting the mobility history information based at least in part on the trigger, the mobility history information comprising a plurality of cells to which the UE has previously attached and corresponding notification areas for each of the plurality of cells.

2. The method of claim 1, wherein identifying the trigger for reporting mobility history information comprises identifying that the second cell is not within the notification area.

3. The method of claim 1, wherein identifying the trigger for reporting mobility history information comprises:
identifying, upon the reselecting to the second cell, that a neighbor list for the second cell excludes the first cell.

4. The method of claim 1, wherein identifying the trigger for reporting mobility history information comprises:
performing a connection setup procedure or a connection resume procedure.

5. The method of claim 1, wherein identifying the trigger for reporting mobility history information comprises:
receiving a request for the mobility history information.

6. The method of claim 1, wherein identifying the trigger for reporting mobility history information is based at least in part on expiration of a timer associated with periodic reporting of the mobility history information.

7. The method of claim 1, further comprising:
reporting the mobility history information comprises reporting the mobility history information to the second cell as part of a connection setup procedure, a connection resume procedure, or a notification area update procedure.

8. The method of claim 1, wherein the plurality of cells comprises a predetermined number of cells.

9. The method of claim 1, wherein, in the inactive state, the UE maintains an access stratum context associated with a session connection and is configured for autonomous cell reselection.

10. A method for wireless communication in a wireless communication network comprising a first cell and a second cell, comprising:
receiving, by a base station associated with the second cell, mobility history information from a user equipment (UE) via the second cell, the mobility history information comprising a plurality of cells to which the UE has previously attached and corresponding notification areas for each of the plurality of cells, the UE having reselected to the second cell in an inactive state;
identifying, based at least in part on the mobility history information, that the first cell is an anchor cell for the UE and a notification area corresponding to the first cell for the UE; and
determining, based at least in part on the mobility history information, whether to associate or disassociate the second cell with the notification area.

11. The method of claim 10, wherein the second cell is not associated with the notification area upon receiving the mobility history information for the UE, and wherein the determining comprises determining to associate the second cell with the notification area for the UE, the method further comprising sending a setup request for a logical connection between the first cell and the second cell.

12. The method of claim 11, further comprising:
retrieving a context for the UE from the first cell;
performing a connection switch procedure to switch a session connection for the UE from the first cell to the second cell; and
performing a notification area registration to associate the second cell with the notification area for the UE.

13. The method of claim 12, further comprising:
receiving, from a core network, downlink data traffic for the UE; and
sending, via the logical connection, a paging request to the first cell to page the UE via the first cell.

14. The method of claim 11, further comprising:
receiving a setup response indicating a failure to setup the logical connection between the first cell and the second cell; and
determining to refrain from associating the second cell with the notification area for the UE.

15. The method of claim 10, wherein the second cell is associated with the notification area upon receiving the mobility history information for the UE, and wherein the determining comprises determining to disassociate the second cell with the notification area for the UE based at least in part on the mobility history information.

16. The method of claim 15, further comprising:
performing a notification area registration to disassociate the second cell from the notification area for the UE.

17. The method of claim 10, wherein the second cell is associated with a second, different notification area upon receiving the mobility history information for the UE, the method further comprising: determining to merge the second notification area with the notification area.

18. The method of claim 10, wherein the second cell is associated with a second, different notification area upon receiving the mobility history information for the UE, the method further comprising: determining to disassociate the second cell with the second notification area and associate the cell with the notification area.

19. An apparatus for wireless communication, comprising:
means for transitioning, at a user equipment (UE), from a connected state with a first cell to an inactive state;
means for identifying a notification area configured for the inactive state comprising at least the first cell;
means for reselecting, while in the inactive state and independently of the first cell, to a second cell;
means for identifying, while in the inactive state, a trigger for reporting mobility history information; and
means for reporting the mobility history information based at least in part on the trigger, the mobility history information comprising a plurality of cells to which the UE has previously attached and corresponding notification areas for each of the plurality of cells.

20. An apparatus for wireless communication, comprising:
means for receiving, by a base station associated with the second cell, mobility history information from a user equipment (UE) via the second cell, the mobility history information comprising a plurality of cells to which the UE has previously attached and corresponding notification areas for each of the plurality of cells, the UE having reselected to the second cell in an inactive state;
means for identifying, based at least in part on the mobility history information, that the first cell is an anchor cell for the UE and a notification area corresponding to the first cell for the UE; and
means for determining, based at least in part on the mobility history information, whether to associate or disassociate the second cell with the notification area.

21. An apparatus for wireless communication, comprising:
a processor;
memory in electronic communication with the processor; and
instructions stored in the memory and executable by the processor to cause the apparatus to:
transition, at a user equipment from a connected state with a first cell to an inactive state;
identify a notification area configured for the inactive state comprising at least the first cell;
reselect, while in the inactive state and independently of e first cell, to a second cell;
identify, while in the inactive state, a trigger for reporting mobility history information; and
report the mobility history information based at least in part on the trimer, the mobility history information comprising a plurality of cells to which the UE has previously attached and corresponding notification areas for each of the plurality of cells.

22. The apparatus of claim 21, wherein the instructions to identify the trigger for reporting mobility history information are executable by the processor to cause the apparatus to:
identify that the second cell is not within the notification area.

23. The apparatus of claim 1 wherein the instructions to identify the trigger for reporting mobility history information are executable by the processor to cause the apparatus to:
identify, upon the reselecting to the second cell, that a neighbor list for second cell excludes the first cell.

24. The apparatus of claim 21, wherein the instructions to identify the trigger for reporting mobility history information are executable by the processor to cause the apparatus to:
perform a connection setup procedure or a connection resume procedure.

25. The apparatus of claim 21, wherein the instructions to identify the trigger for reporting mobility history information are executable by the processor to cause the apparatus to:
receive a request for the mobility history information.

26. The apparatus of claim 21, wherein the instructions to identify the trigger for reporting mobility history information are based at least in part on expiration of a timer associated with periodic reporting of the mobility history information.

27. The apparatus of claim 21, wherein the instructions are further executable by the processor to cause the apparatus to:
report the mobility history information comprises reporting the mobility history information to the second cell as part of a connection setup procedure, a connection resume procedure, or a notification area update procedure.

28. The apparatus of claim 21, wherein the plurality of cells comprises a predetermined number of cells.

29. The apparatus of claim 21, wherein, in the inactive state, the UE maintains an access stratum context associated with a session connection and is configured for autonomous cell reselection.

30. An apparatus for wireless communication, comprising:
a processor;
memory in electronic communication with the processor; and
instructions stored in the memory and executable by the processor to cause the apparatus to:
receive, by a base station associated with the second cell, mobility history information from a user equipment (UE) via the second cell, the mobility history information comprising a plurality of cells to which the UE has previously attached and corresponding notification areas for each of the plurality of cells, the UE having reselected to the second cell in an inactive state;
identify, based at least in part on the mobility history information, that the first cell is an anchor cell for the UE and a notification area corresponding to the first cell for the UE; and
determine, based at least in part on the mobility history information, whether to associate or disassociate the second cell with the notification area.

31. The apparatus of claim 30, wherein the second cell is not associated with the notification area upon receiving the mobility history information for the UE, and wherein the instructions to determine whether to associate or disassociate with the second cell are executable by the processor to cause the apparatus to:
determine to associate the second cell with the notification area for the UE; and
send a setup request for a logical connection between the first cell and the second cell.

32. The apparatus of claim 31, wherein the instructions are further executable by the processor to cause the apparatus to:
retrieve a context for the UE from the first cell;
perform a connection switch procedure to switch a session connection for the UE from the first cell to the second cell; and
perform a notification area registration to associate the second cell with the notification area for the UE.

33. The apparatus of claim 32, wherein the instructions are further executable by the processor to cause the apparatus to:
receive, from a core network, downlink data traffic for the UE; and
send, via the logical connection, a paging request to the first cell to page the UE via the first cell.

34. The apparatus of claim 31, wherein the instructions are further executable by the processor to cause the apparatus to:
receive a setup response indicating a failure to setup the logical connection between the first cell and the second cell; and
determine to refrain from associating the second cell with the notification area for the UE.

35. The apparatus of claim 30, wherein the second cell is associated with the notification area upon receiving the mobility history information for the UE, and wherein the instructions to determine whether to associate or disassociate with the second cell are executable by the processor to cause the apparatus to:
determine to disassociate the second cell with the notification area for the UE based at least in part on the mobility history information.

36. The apparatus of claim 35, wherein the instructions are further executable by the processor to cause the apparatus to:
perform a notification area registration to disassociate the second cell from the notification area for the UE.

37. The apparatus of claim 30, wherein the second cell is associated with a second, different notification area upon receiving the mobility history information for the UE, wherein the instructions are further executable by the processor to cause the apparatus to:
determine to merge the second notification area with the notification area.

38. The apparatus of claim 30, wherein the second cell is associated with a second, different notification area upon receiving the mobility history information for the UE, wherein the instructions are further executable by the processor to cause the apparatus to:
determine to disassociate the second cell with the second notification area and associate the cell with the notification area.

39. A non-transitory computer-readable medium storing code for wireless communication, the code comprising instructions executable by a processor to:
transition, at a user equipment (UE), from a connected state with a first cell to an inactive state;
identify a notification area configured for the inactive state comprising at least the first cell;
reselect, while in the inactive state and independently of the first cell, to a second cell;
identify, while in the inactive state, a trigger for reporting mobility history information; and
report the mobility history information based at least in part on the trigger, the mobility history information comprising a plurality of cells to which the UE has previously attached and corresponding notification areas for each of the plurality of cells.

40. A non-transitory computer-readable medium storing code for wireless communication, the code comprising instructions executable by a processor to:
receive, by a base station associated with the second cell, mobility history information from a user equipment (UE) via the second cell, the mobility history information comprising a plurality of cells to which the UE has previously attached and corresponding notification areas for each of the plurality of cells, the UE having reselected to the second cell in an inactive state;
identify, based at least in part on the mobility history information, that the first cell is an anchor cell for the UE and a notification area corresponding to the first cell for the UE; and
determine, based at least in part on the mobility history information, whether to associate or disassociate the second cell with the notification area.
